(19) United States
(12) Patent Application Publication
(10) Pub. No.: US 2023/0195291 A1
(43) Pub. Date: Jun. 22, 2023

(54) INFORMATION PROCESSING SYSTEM

(71) Applicant: FUJIFILM Business Innovation Corp., Tokyo (JP)

(72) Inventor: Yasunari KISHIMOTO, Kanagawa (JP)

(73) Assignee: FUJIFILM Business Innovation Corp., Tokyo (JP)

(21) Appl. No.: 17/828,027

(22) Filed: May 30, 2022

(30) Foreign Application Priority Data
Dec. 22, 2021 (JP) 2021-208647

(51) Int. Cl. G06F 3/04845; G06T 13/00; G06F 3/04847

(52) U.S. Cl. CPC G06F 3/04845; G06T 13/00; G06F 3/04847; G06T 2200/24; G06F 2203/04803

(57) ABSTRACT

An information processing system that processes a display element displayed on a display unit, includes a processor configured to acquire change information including a change content of display according to a time series performed on the display element, and determine a display content of an edit screen for providing an instruction to change the display of the display element according to the time series, based on the acquired change information.

### CROSS-REFERENCE TO RELATED APPLICATIONS

This application is based on and claims priority under 35 USC 119 from Japanese Patent Application No. 2021-208647 filed Dec. 22, 2021.

### BACKGROUND

### (i) Technical Field

The present invention relates to an information processing system.

### (ii) Related Art

JP2003-263648A discloses a process of applying an input common state change attribute to component 3D objects to determine individual timelines of selected objects, and creating animation data including the individual timelines of two or more component 3D objects.

JP2007-41861A discloses a process causing playback in a case where a user indicates an object and an editable area is set in the object, displaying an input area at a position where the indicated object is located, and waiting for a user's input.

### SUMMARY

By displaying an edit screen for editing a display element, the user can edit the display element through this edit screen.

Here, in a case where a display content of the edit screen is determined without considering information regarding a change in the display made for a display element, which has already been set, the information regarding the change is not reflected in the edit screen. In this case, the user's workload becomes large, for example, the user needs to acquire information regarding this change by himself/herself.

Aspects of non-limiting embodiments of the present disclosure relate to an information processing system capable of reducing the workload in a case where a user edits a display element, as compared with a case where a display content of an edit screen is determined without considering information regarding display changes made for the display element.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system that processes a display element displayed on a display unit, including a processor configured to acquire change information including a change content of display according to a time series performed on the display element, and determine a display content of an edit screen for providing an instruction to change the display of the display element according to the time series, based on the acquired change information.

### BRIEF DESCRIPTION OF THE DRAWINGS

Exemplary embodiment(s) of the present invention will be described in detail based on the following figures, wherein:

FIG. 1 is a diagram showing an overall configuration of an information processing system;

FIG. 2 is a diagram showing an example of the hardware configuration of a management server and a user terminal;

FIG. 3 is a flowchart showing a flow of a process executed by the information processing system of the present exemplary embodiment;

FIG. 4 is a diagram showing an example of an edit screen displayed on a user terminal;

FIG. 5 is an enlarged view showing a portion indicated by a reference numeral V in FIG. 4;

FIG. 6 is a diagram showing a display example of the edit screen;

FIG. 7 is a diagram showing a display example of the edit screen;

FIG. 8 is a diagram for explaining a reception display;

FIG. 9 is a diagram for explaining a reception display;

FIG. 10 is a diagram for explaining a reception display; and

FIG. 11 is a diagram showing a display example in a moving image display unit.

### DETAILED DESCRIPTION

Hereinafter, an exemplary embodiment of the present invention will be described with reference to the accompanying drawings.

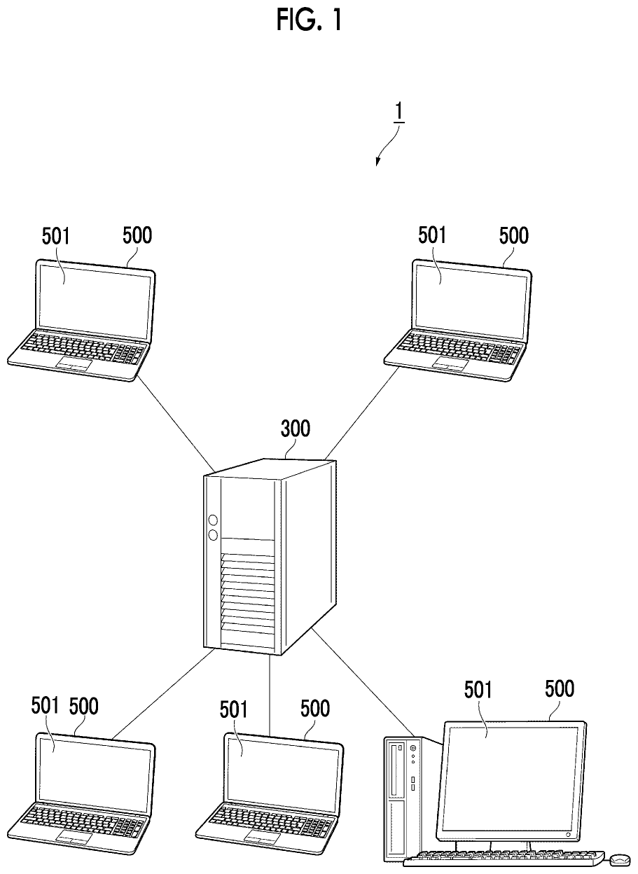

FIG. 1 is a diagram showing an overall configuration of an information processing system 1 according to the present exemplary embodiment.

The information processing system 1 is provided with a management server 300 as an example of an information processing device. Further, the information processing system 1 is provided with a user terminal 500 owned by each user.

The user terminals 500 are provided according to the number of users, and in the present exemplary embodiment, a plurality of user terminals 500 are provided. Further, each of the user terminals 500 is provided with a display unit 501 for displaying information. The display unit 501 is, for example, a liquid crystal display, an organic EL display, or the like.

The user terminal 500 is, for example, a Personal Computer (PC). The user terminal 500 is not limited to a PC, and may be a terminal device other than a PC, such as a smartphone or a tablet terminal.

In the present exemplary embodiment, the user terminal 500 and the management server 300 are connected to each other via a communication line such as an Internet line. The user terminal 500 may be configured to integrate the management server 300 and the present processing system to utilize local terminal communication. This is one of the means for embodying application software only on the terminal.

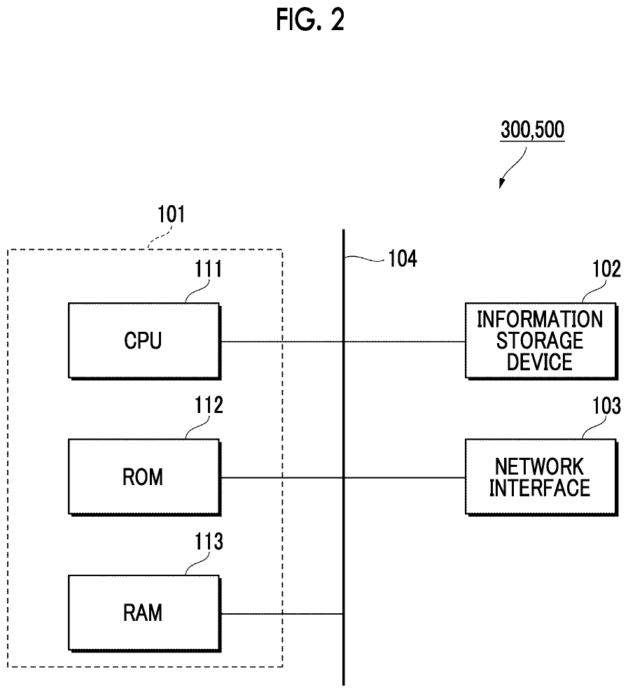

FIG. 2 is a diagram showing an example of the hardware configuration of the management server 300 and the user terminal 500.

Each of the management server 300 and the user terminal 500 includes a control unit 101 that controls the operation of the entire apparatus, an information storage device 102 that stores information, and a network interface 103 that achieves communication via a Local Area Network (LAN) cable or the like.

The control unit 101 includes a Central Processing Unit (CPU) 111 as an example of a processor, a Read Only Memory (ROM) 112 in which a program is stored, and a Random Access Memory (RAM) 113 to be used as a work area.

The CPU 111 may be multi-core. Further, the ROM 112 may be a rewritable non-volatile semiconductor memory. The control unit 101 is a so-called computer.

In the present exemplary embodiment, the CPU 111 executes a program stored in the ROM 112 or the like to execute a process described later.

Examples of the information storage device 102 include a hard disk drive. The hard disk drive is a device that reads and writes data from and to a non-volatile storage medium in which a magnetic material is coated on the surface of a disk-shaped substrate. However, the information storage device 102 may be a semiconductor memory or a magnetic tape.

In addition, the management server 300 and the user terminal 500 include an input device such as a keyboard and a mouse and a display unit 501 (not shown in FIG. 2) composed of a liquid crystal display, and the like.

The control unit 101, the information storage device 102, and the network interface 103 are connected to each other through a bus 104 or a signal line (not illustrated).

Here, the program to be executed by the CPU 111 can be provided to the management server 300 and the user terminal 500 by being stored in a computer readable recording medium such as a magnetic recording medium (a magnetic tape, a magnetic disk, etc.), an optical recording medium (optical disk, etc.), an optical magnetic recording medium, or a semiconductor memory.

Further, the program to be executed by the CPU 111 may be provided to the management server 300 and the user terminal 500 by using a communication means such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the information processing system 1 of the present exemplary embodiment, a still image including a plurality of display elements is input as an input image, and then a moving image including the plurality of display elements is generated from the input image.

Further, in the information processing system 1 of the present exemplary embodiment, each of the display elements included in the moving image can be edited, and after changing the arrangement position, form, or the like of the display elements, a moving image in which the display elements are included is generated.

Here, examples of changing the form of the display element include changing the shape, color, transparency, size, length, or the like of the display element.

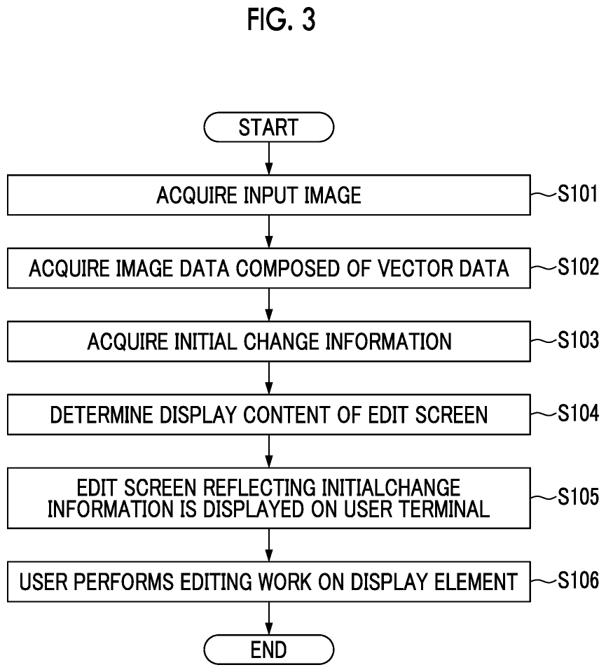

FIG. 3 is a flowchart showing a flow of a process executed by the information processing system 1 of the present exemplary embodiment.

In the present exemplary embodiment, first, an input image which is a still image is input to the information processing system 1, and the management server 300 acquires the input image (step S101). More specifically, in the present exemplary embodiment, for example, an input image is input via the user terminal 500, and the management server 300 acquires the input image from the user terminal 500.

Then, the CPU 111 as an example of the processor of the management server 300 vectorizes the input image, and acquires the image data composed of the vector data (step S102).

This image data composed of vector data includes information on the arrangement position of the display element and information on the form of the display element such as the shape, color, transparency, size, and length of the display element. Further, the image data composed of vector data may include information regarding the name of the display element (for example, the image data can be generated from the file name of the original image or the image recognition output).

In this image data composed of vector data, information regarding an arrangement position, information regarding a form, and information regarding a name are associated with each of the display elements.

Further, the image data composed of vector data may include change information that is information regarding the change of the display element.

In other words, this image data composed of vector data may include change information that is included in the image data from the beginning and indicates the content of the change of the display element. Hereinafter, this change information included in the image data from the beginning is referred to as “initial change information”.

This initial change information is also associated with each of the display elements.

The initial change information is information including the content of the change in display according to the time series, performed on the display element.

The CPU 111 as an example of the processor provided in the management server 300 acquires the initial change information which is information including the content of the change in display according to the time series, performed on the display element, for each of the display elements, from the image data composed of the above vector data (step S103).

In other words, the CPU 111 of the management server 300 acquires initial change information indicating the content of a change made to the display element displayed on the display unit 501 of the user terminal 500, and that changes at least one of the arrangement position, shape, color, transparency, size, or length over time or with the passage of time.

Then, the CPU 111 of the management server 300 determines the display content of an edit screen (described later) displayed on the display unit 501 of the user terminal 500, based on the acquired initial change information (step S104).

This edit screen is an edit screen for instructing a change in the display of the display element in time series, and the CPU 111 of the management server 300 determines the display content of the edit screen, based on the initial change information.

In other words, the edit screen is an edit screen for showing information regarding changes in the display of display elements in time series, and is an edit screen that is referred to by the user in a case of editing a moving image.

The CPU 111 of the management server 300 determines the display content of this edit screen to be referred to in a case where the user edits the moving image, based on the acquired initial change information.

As described above, the image data composed of the vector data may include the above-described initial change information that is information regarding the change of the display element, for each of the display elements included in the image data.

The CPU 111 of the management server 300 acquires the initial change information, for each display element, from the image data composed of the vector data.

Then, the CPU 111 of the management server 300 reflects the acquired initial change information on the edit screen. Thus, in the present exemplary embodiment, the edit screen reflecting the initial change information is displayed on the user terminal 500 (step S105).

In this case, the user can grasp what kind of change is made at the time of playing back the moving image, for each of the display elements included in the moving image, by referring to the edit screen. Further, the user can grasp a timing at which changes are made, for each of the display elements included in the moving image, by referring to the edit screen.

In the present exemplary embodiment, in a case where the CPU 111 of the management server 300 determines the display content of the edit screen, the determined content is transmitted to the user terminal 500. In response to this, the user terminal 500 displays an edit screen in which the determined display content is reflected.

Then, in this case, as described above, by referring to the edit screen, the user can grasp what kind of change is made, for each of the display elements included in the moving image. Further, the user can grasp a timing at which changes are made, for each of the display elements included in the moving image.

Further, in the present exemplary embodiment, the user can grasp the content of the change already set for each of the display elements, by referring to this edit screen.

In the present exemplary embodiment, the CPU 111 of the management server 300 performs the process on the edit screen displayed on the user terminal 500, but the user terminal 500 may perform this process, and the management server 300 may perform a part of the process on the edit screen, and the user terminal 500 may perform the other part.

After that, in the present exemplary embodiment, the user performs an editing work on each of the display elements as needed (step S106).

In the present exemplary embodiment, the user can further make changes wanted by the user, for each of the display elements, by performing an operation on the generated edit screen.

In a case where this further change is made by the user, the content of the change is reflected in the above vector data, and vector data reflecting the content of the change is generated.

In other words, in this case, the content of the change by the user is reflected in the generated moving image.

In a case where the user makes further changes to the display elements and the moving image is completed, the application program stored in advance in the user terminal 500 is used to play the moving image.

This application program changes the arrangement position and form of the display element, for each display element with the passage of time, based on the change information associated with each of the display elements.

Thus, in a case where the moving image is played back, the arrangement position and form of each of the display elements change over time.

Initial Display on Edit Screen

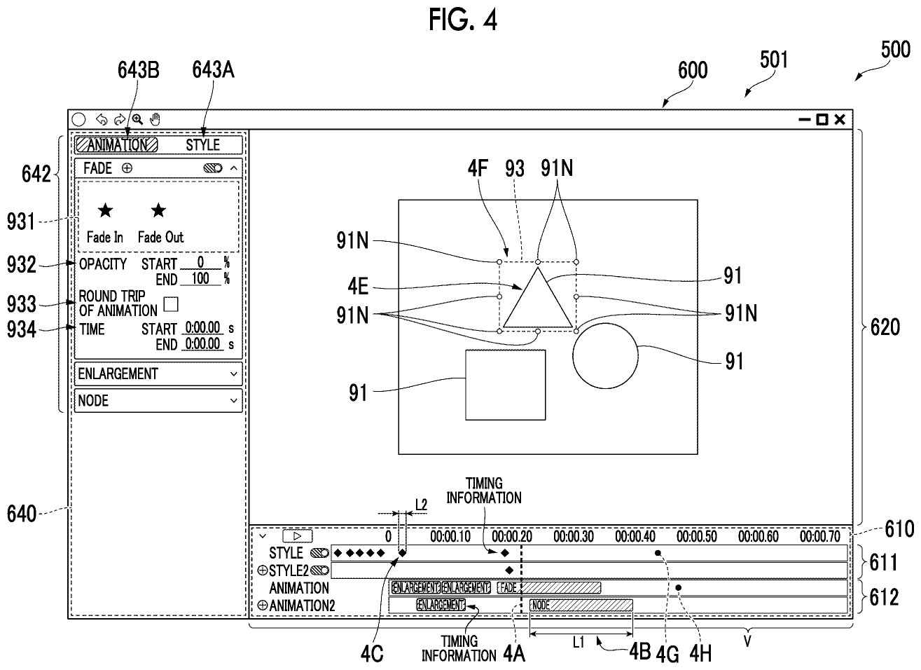

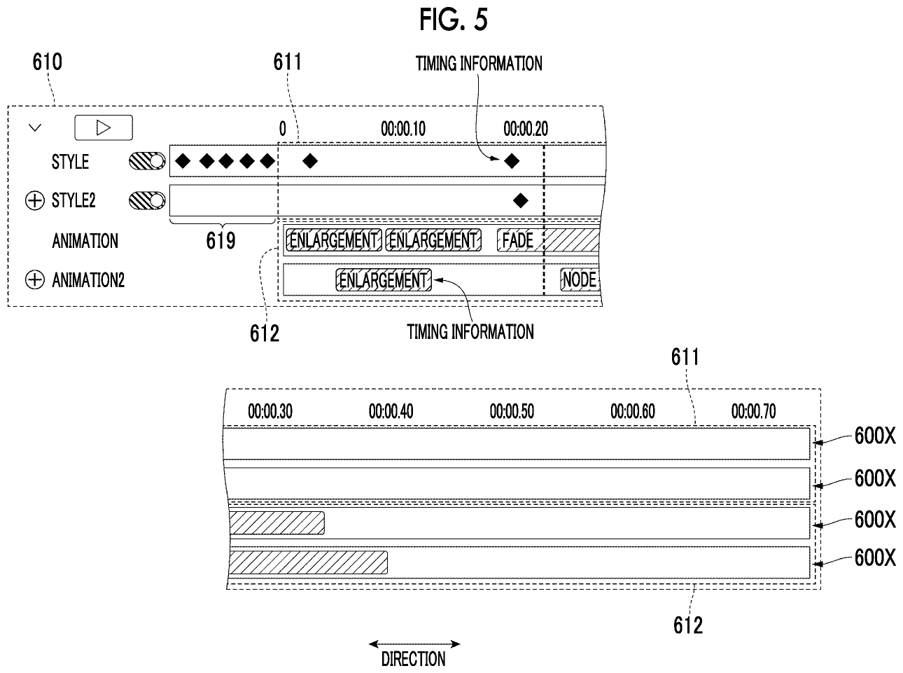

FIG. 4 is a diagram showing an example of an edit screen displayed on the user terminal 500. FIG. 5 is an enlarged view showing a portion indicated by a reference numeral V in FIG. 4. In other words, FIGS. 4 and 5 are diagrams for explaining an edit screen 600 in which the display content determined by the CPU 111 of the management server 300 is reflected. In other words, FIGS. 4 and 5 are diagrams for explaining the edit screen 600 in which the initial change information is reflected.

The edit screen 600 (see FIG. 4), in which the CPU 111 of the management server 300 determines the display content, is displayed on the display unit 501 of the user terminal 500.

The edit screen 600 shown in FIGS. 4 and 5 is an edit screen 600 in a case where the user has not yet made further changes to the display elements.

In this edit screen 600 shown in FIG. 4, a display area 610 corresponding to the time series is provided at the lower part.

In other words, at the lower part of the edit screen 600, the display area 610 for displaying information regarding a change in a display element whose arrangement position and form change over time is provided.

Further, above the display area 610, a moving image display portion 620 for displaying the generated moving image is provided. In FIG. 4, the state of the moving image at the time indicated by a reference numeral 4A is shown in the moving image display portion 620.

In the present exemplary embodiment, the CPU 111 of the management server 300 determines the display content of the edit screen 600, as described above. In making this determination, the CPU 111 of the management server 300 determines the display in the display area 610 located at the bottom of the edit screen 600.

In determining the display in the display area 610, the CPU 111 of the management server 300 determines the display content in the display area 610, based on the above-described initial change information that is included in the vector data and acquired from the vector data.

In the present exemplary embodiment, timing information, which is information indicating when the display element is changed, is displayed in the display area 610.

Based on the acquired initial change information, the CPU 111 of the management server 300 determines the display position of the timing information, which is the information indicating when the change specified by the initial change information is performed, in the display area 610.

In the present exemplary embodiment, each piece of the initial change information includes time information indicating when the display element is changed, and the CPU 111 of the management server 300 determines the display position of the timing information, based on the acquired time information.

Further, the initial change information also includes information regarding the content of the change (hereinafter referred to as “change content information”). More specifically, in the initial change information, the change content information is associated with each of the display elements.

Based on the acquired change content information, the CPU 111 of the management server 300 also displays the change content information at the display location of the timing information.

Examples of the change content information include information regarding “fade”, “enlargement”, “node”, “transformation”, “transparency”, and the like (details will be described later).

The CPU 111 of the management server 300 varies the display position of the timing information, depending on whether a change specified by the acquired initial change information is a first change or a second change different from the first change.

More specifically, in a case where the change specified by the acquired initial change information is a style change that is an example of the first change, the CPU 111 of the management server 300 displays the timing information regarding this style change in the first area 611 in the display area 610 (see FIG. 5).

Further, in a case where the change specified by the acquired initial change information is an animation change that is an example of a second change different from the first change, the CPU 111 of the management server 300 displays the timing information regarding this animation change in a second area 612 located below the first area 611.

In the present exemplary embodiment, the display area 610 (see FIG. 5) is provided with a first area 611 and a second area 612, as areas corresponding to the time series.

The first area 611 and the second area 612 extend in one direction. Specifically, the first area 611 and the second area 612 extend in the lateral direction of the edit screen 600 (see FIG. 4). Further, the first area 611 and the second area 612 are arranged so as to be adjacent to each other and side by side in the vertical direction.

The extending direction of the first area 611 and the second area 612 is not particularly limited, and may be other directions such as the vertical direction of the edit screen 600.

Here, “animation change” refers to a change requiring time to change the display. More specifically, “animation change” refers to a change in which the time required to change the display exceeds a predetermined threshold.

In the present exemplary embodiment, examples of the animation change include “fade”, “enlargement”, and “node”, which will be described later.

For display elements whose animation is changed, the display gradually changes with the passage of time during playback of the moving image.

Further, “style change” refers to a form change that does not require time to change the display, as compared with the animation change. Specifically, in the present exemplary embodiment, examples of the style change include “transformation” and “transparency” to be described later.

For the display element to be changed by the style change, the display is changed in a time shorter than the above-described predetermined threshold value. In other words, the style change refers to a change in the form in which the time required to change the display does not exceed the above-described predetermined threshold.

In the present exemplary embodiment, for the display element to be changed by the style change, display is changed instantly.

Here, the animation change can be regarded as a time-requiring change that is a change requiring time to change the display, and the style change can be regarded as a short-time change that is a change having a shorter time required to change the display than the time-requiring change.

In the present exemplary embodiment, the CPU 111 of the management server 300 varies the display position of the timing information, depending on whether the change specified by the acquired initial change information is an animation change that is a time-requiring change or a style change that is a short-time change.

In the initial change information of the present exemplary embodiment, each of the display elements is associated with information such as “fade”, “enlargement”, “node”, “transformation”, and “transparency” that is an example of the change content information, which is information indicating the content of the change in display.

The CPU 111 of the management server 300 determines whether a change made to the display elements is an animation change or a style change, based on the change content information such as “fade”, “enlargement”, “node”, “transformation”, and “transparency”, included in the acquired initial change information.

In the present exemplary embodiment, in a case where the change content information included in the acquired initial change information is “transformation” or “transparent”, the CPU 111 of the management server 300 determines that the change made to the display element is a style change.

Further, in a case where the change content information included in the acquired initial change information is “fade”, “enlargement”, or “node”, the CPU 111 of the management server 300 determines that the change made to the display element is an animation change.

In a case where it is determined that the change specified by the acquired initial change information is an animation change that is an example of the time-requiring change, the CPU 111 of the management server 300 displays the timing information corresponding to this animation change in the second area 612.

In the present exemplary embodiment, the change content information, which is information regarding the content of the change in display, is also displayed at the display location of the timing information. Specifically, in the present exemplary embodiment, as shown in FIGS. 4 and 5, the word of any one of “fade”, “enlargement”, and “node” is displayed at the display location of the timing information.

On the other hand, in a case where it is determined that the change specified by the acquired initial change information is a style change that is an example of a short-time change, the CPU 111 of the management server 300 displays the timing information corresponding to this style change in the first area 611.

In a case where the change specified by the acquired initial change information is a style change, in the present exemplary embodiment, the change content information including words such as “transformation” and “transparency” is displayed at the display location of the timing information. However, the present invention is not limited to this, and the change content information may be displayed.

Here, in a case where the timing information and the change content information regarding the animation change, and the timing information and the change content information regarding the style change are displayed on one row (timeline), the amount of information displayed in this one row increases, and the display may be difficult to see.

On the other hand, in the present exemplary embodiment, the display positions of the timing information and the change content information vary, depending on the content of the change. In other words, in the present exemplary embodiment, the display positions of the timing information and the change content information vary, depending on the type of change.

In this case, the amount of information displayed in one row is reduced, and the user can easily see the display.

In the present exemplary embodiment, the CPU 111 of the management server 300 displays the timing information in the first area 611 and displays the timing information in the second area 612 such that the display standard in the one direction (horizontal direction of the edit screen 600) in a case where the timing information is displayed in the first area 611 (see FIG. 5) matches the display standard in the one direction in a case where the timing information is displayed in the second area 612.

In other words, the CPU 111 of the management server 300 matches the reference position of the display in the one direction in a case where the timing information is displayed in the first area 611 with the reference position of the display in the one direction in a case where the timing information is displayed in the second area 612.

In the present exemplary embodiment, timing information is displayed in each of the first area 611 and the second area 612, and the reference positions for the display positions of the timing information, which is the reference position in the one direction in the first area 611 and the second area 612 match.

More specifically, in the present exemplary embodiment, the timing information is displayed based on the predetermined reference time, but the position of the reference time in one direction in the first area 611 and the position of the reference time in one direction in the second area 612 match.

In this case, in a case where the animation change and the style change are performed at the same time, the display position of the timing information regarding the animation change in one direction and the display position of the timing information regarding the style change in one direction match.

Further, in the present exemplary embodiment, in a case where the change specified by the acquired initial change information is the animation change that is the time-requiring change, the CPU 111 of the management server 300 increases the area where the timing information is displayed.

Specifically, in a case where the change specified by the acquired initial change information is an animation change, the CPU 111 of the management server 300 sets the length of the area where the timing information is displayed, that is, the length in one direction to, for example, the length L1, as shown by a reference numeral 4B in FIG. 4.

On the other hand, in a case where the change specified by the acquired initial change information is a style change, the CPU 111 of the management server 300 sets the length of the area where the timing information is displayed, that is, the length in one direction to, for example, the length L2 that is smaller than the length L1, as shown by a reference numeral 4C in FIG. 4.

More specifically, in the present exemplary embodiment, as shown by a reference numeral 4C in FIG. 4, a dot-shaped image is displayed as timing information for the style change.

Further, in the present exemplary embodiment, as shown by a reference numeral 4B in FIG. 4, a band-shaped image extending in one direction and having a width dimension larger than the width dimension of the dot-shaped image is displayed as timing information for the animation change. Here, the width dimension refers to the length in the direction in which the first area 611 and the second area 612 extend.

In a case where the change specified by the acquired initial change information is a style change, the CPU 111 of the management server 300 displays the dot-shaped image in the first area 611.

Further, in a case where the change specified by the acquired initial change information is an animation change, the CPU 111 of the management server 300 displays a band-shaped image having a width dimension larger than the width dimension of the dot-shaped image in the second area 612.

Further, in a case where the change specified by the acquired initial change information is an animation change, the CPU 111 of the management server 300 increases or decreases the length of display area of the timing information, that is, the length in one direction, according to the required time that is the time required for the animation change.

In other words, in a case where the change specified by the acquired initial change information is an animation change, the CPU 111 of the management server 300 increases or decreases the length of the strip-shaped image, according to the required time that is the time required for the animation change.

More specifically, in a case where the required time, which is the time required for the animation change, is long, the CPU 111 of the management server 300 increases the length of the timing information display area composed of the strip-shaped image.

Further, in a case where the required time is short, the CPU 111 of the management server 300 reduces the length of the timing information display area composed of the strip-shaped image.

Thus, the user can easily grasp the size of the time required to change the animation, by referring to the edit screen 600.

In the present exemplary embodiment, as shown in FIG. 5, each of the first area 611 and the second area 612 is provided with a plurality of rows of display portions 600X extending in the horizontal direction in FIG. 5.

Specifically, in the present exemplary embodiment, each of the first area 611 and the second area 612 is provided with two rows of display portions 600X extending in the horizontal direction in FIG. 5.

The display portion 600X may have two or more rows, or the number of rows of the display portion 600X may increase according to a user's instruction.

In the present exemplary embodiment, a plurality of display portions 600X for displaying information regarding each of the animation change and the style change are provided. Thus, the user refers to the edit screen 600 more easily, as compared with the case where only one display portion 600X is provided corresponding to each of the animation change and the style change.

For example, it is also assumed a case where the animation change is performed a plurality of times and the timings at which the animation changes are performed overlaps among the animation changes.

In this case, in a case where there is only one display portion 600X for the animation change, it may be difficult for the user to refer to the edit screen 600.

On the other hand, in a case where a plurality of display portions 600X are provided corresponding to each of the animation change and the style change as in the present exemplary embodiment, the plurality of pieces of timing information having a relationship, in which the timings of the change overlap with each other, can be displayed on different display portions 600X. In this case, the user can easily refer to the edit screen 600.

Editing Work by User

Further, in the present exemplary embodiment, as described above, the user can perform an editing work on each of the display elements.

In other words, in the present exemplary embodiment, it is possible to receive further changes by the user, for each of the display elements. In other words, in the present exemplary embodiment, the user can individually perform the editing work on each of the display elements.

In the present exemplary embodiment, in addition to changing the display element by the initial change information included in the image data from the beginning, in a case where the user wants to further change the display element, the display element is changed based on what the user wants.

In a case of changing the display element based on what the user wants, information regarding the content of the change (hereinafter referred to as “user change information”) is received from this user, and the content of the change specified by this user change information is reflected in the image data composed of the above vector data.

In the present exemplary embodiment, in a case of receiving further changes by the user, as shown in FIG. 4, the CPU 111 of the management server 300 displays a reception display 640 which is an example of a display for receiving further changes to the display elements from the user, on the display unit 501 of the user terminal 500.

Specifically, the CPU 111 of the management server 300 displays, as the reception display 640, a first reception screen 641 (not shown in FIG. 4) for receiving the content of a style change, which is an example of one type of change from the user, and a second reception screen 642 for the user to receive the content of the animation change which is an example of another type of change, on the display unit 501 of the user terminal 500.

The first reception screen 641 and the second reception screen 642 may be displayed on the edit screen 600 at all times, or may be displayed in a case where the user edits the display element.

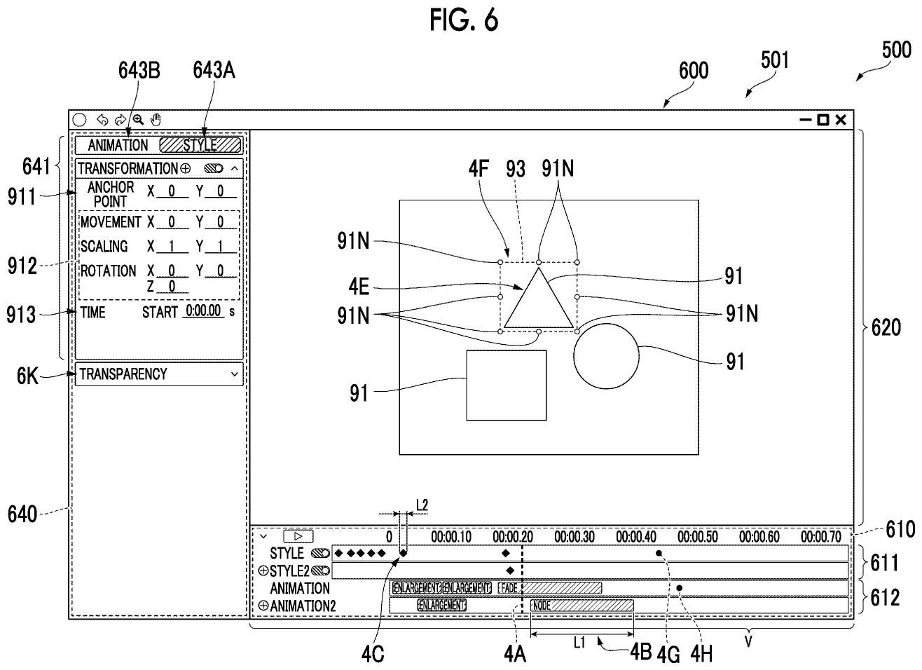

In the present exemplary embodiment, the CPU 111 of the management server 300 displays, as the reception display 640 for receiving the change by the user, as shown in FIG. 6 (a diagram showing a display example of the edit screen 600), a first reception screen 641 which is a screen for receiving the content of the style change from the user, on the display unit 501 of the user terminal 500.

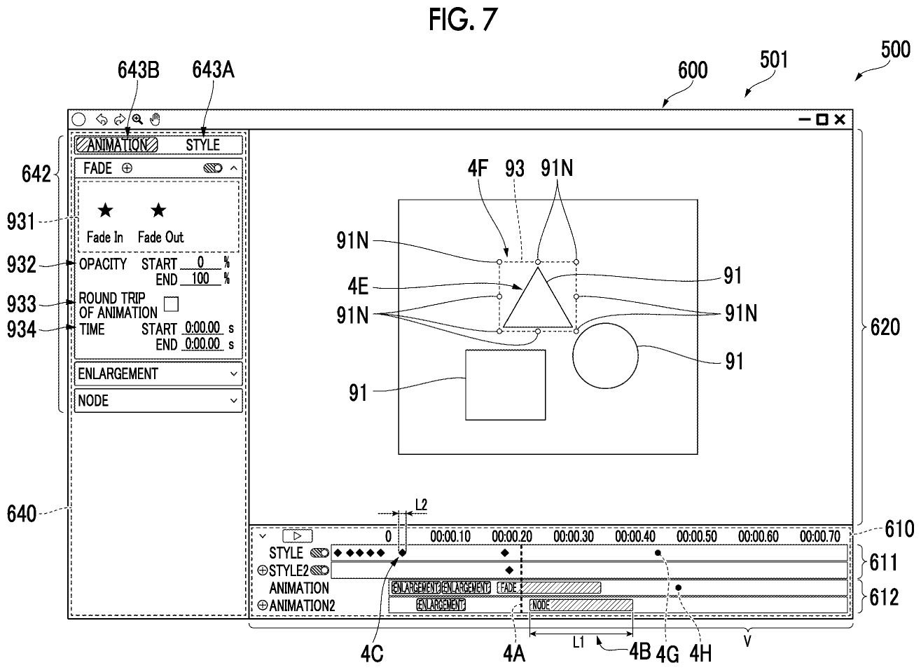

Further, as shown in FIG. 7 (a diagram showing a display example of the edit screen 600), the CPU 111 of the management server 300 displays a second reception screen 642 which is a screen for the user to receive the content of the animation change, on the display unit 501 of the user terminal 500.

In the present exemplary embodiment, the first reception screen 641 and the second reception screen 642 are displayed in the left area of the edit screen 600. In other words, the first reception screen 641 and the second reception screen 642 are displayed as a part of the edit screen 600.

Further, in the present exemplary embodiment, as shown in FIGS. 6 and 7, when one of the first reception screen 641 and the second reception screen 642 is displayed, the CPU 111 of the management server 300 prevents the other from being displayed.

In the present exemplary embodiment, the CPU 111 of the management server 300 generates information that when one of the first reception screen 641 and the second reception screen 642 is displayed, prevents the other from being displayed, and transmits this information to the user terminal 500.

Thus, in the present exemplary embodiment, as shown in FIGS. 6 and 7, the user terminal 500 has a form in which when one of the first reception screen 641 and the second reception screen 642 is displayed, prevents the other from being displayed.

As shown in FIG. 6, two tabs, a first tab 643A and a second tab 643B, selected by the user are displayed at the upper part of the reception display 640.

In the present exemplary embodiment, in a case where the first tab 643A is selected, the first reception screen 641 for the user to receive the content of the style change is displayed. Further, in a case where the second tab 643B is selected, the second reception screen 642 (see FIG. 7) for the user to receive the content of the animation change is displayed.

In this case, as described above, the user terminal 500 has a form in which when one of the first reception screen 641 and the second reception screen 642 is displayed, prevents the other from being displayed.

Further, in the present exemplary embodiment, the user can set the background image included in the input image, as one of the editing works.

In the present exemplary embodiment, the CPU 111 of the management server 300 specifies a display element representing a background image among display elements from an input image composed of vector data, and acquires information regarding the display element of the background image.

The CPU 111 of the management server 300 acquires information regarding a display element representing a background image from image data composed of vector data.

More specifically, the CPU 111 of the management server 300 acquires information regarding display elements representing a background image located in the background of the generated moving image, from the image data composed of the vector data.

Then, the CPU 111 of the management server 300 performs a process of receiving, from the user, the setting of the display mode in a case where the background image is displayed as a moving image.

In other words, the CPU 111 of the management server 300 performs a process of receiving, from the user, the setting of the display mode in the generated moving image, for the background image.

Specifically, the CPU 111 of the management server 300 gives an instruction to the user terminal 500, and the reception display (not shown) for receiving the display setting for the background image from the user is displayed on the display unit 501 of the user terminal 500.

Then, based on the information input by the user via the reception display, for example, the CPU 111 of the management server 300 makes a setting whether to make the color of the background image in the input image transparent or not, or a setting whether to maintain the color of the background image in the input image or not.

For example, in a case of receiving, from the user, a setting to make the color of the background image transparent, the CPU 111 of the management server 300 makes the color of the background image included in the input image transparent.

In this case, in a case where a new color of the background image is set separately by the user, the color of the background image included in the final moving image becomes this new color.

In other words, in a case of receiving the setting to make the color of the background image transparent, the color of the background image that was in the input image is transparent, and this color of the background image that was in the input image does not affect the moving image. On the other hand, in this case, the above-described new color set by the user affects the moving image, and this new color becomes the color of the background image included in the moving image.

Further, in a case of receiving, from the user, a setting to maintain the color of the background image, for example, the CPU 111 of the management server 300 determines the color of the background image included in the moving image, after maintaining the color of the background image that was in the input image.

In this case, in a case where the color of the background image included in the moving image is not separately set by the user, the color of the background image included in the moving image is the color of the background image that was in the input image.

Further, in a case where a specific setting is made in advance by the user, the CPU 111 of the management server 300 sets the state of the display elements displayed on the display unit 501 of the user terminal 500 to a state different from the state in the input image, based on the specific setting.

More specifically, in a case where a specific setting is made in advance by the user, the CPU 111 of the management server 300 sets the state of the display elements in the initial state of the moving image to a state different from the state of the display elements in the input image, based on the specific setting.

More specifically, in a case where a specific setting is made in advance by the user, the CPU 111 of the management server 300 changes the arrangement locations of the display elements included in the image data composed of, for example, vector data, based on the specific setting, and makes the arrangement positions of the display elements different from the arrangement positions in the input image.

More specifically, in a case where a specific setting is made in advance by the user, the CPU 111 of the management server 300 moves each of the display elements to, for example, a position set by the user.

Thus, the arrangement position of the display element in the initial state of the moving image becomes different from the arrangement position in the input image. In this case, the layout of the display element displayed at the start of the moving image is different from the layout in the input image.

Further, in a case where a specific setting is made in advance by the user, the CPU 111 of the management server 300 performs a process on the image data composed of vector data, based on the specific setting, and sets, for example, the form of the display element to a form different from the form of the input image.

Specifically, the CPU 111 of the management server 300, for example, transforms the display element, changes the transparency, and makes the form of the display element different from the form in the input image.

Thus, the form of the display element in the initial state of the moving image becomes different from the form of the display element of the input image.

In this case, the form of the display element displayed at the start of the moving image is different from the form of the input image.

More specifically, in the present exemplary embodiment, as the above-described specific setting made in advance by the user, the user can make the setting for the above-described style change in advance.

In a case where the user has previously set the style change, the CPU 111 of the management server 300 performs at least one of “transformation” or “transparency” as an example of the style change on the display element, and makes the form of the display element different from the form of the input image.

The display elements also include the above background image, and in a case where the user has made a specific setting in advance and the style is changed, the background displayed in the initial state of the moving image may be different from the background in the input image.

In the present exemplary embodiment, at the start of the moving image, the initial state of the moving image is displayed on the user terminal 500 on which the moving image is displayed, but basically, in this case, each of the display elements included in the input image is displayed in the state in the input image.

On the other hand, in a case where the specific setting is made by the user, the specific setting is reflected in the display elements displayed on the user terminal 500, and at the start of the moving image, display elements that reflect the specific setting are displayed on the user terminal 500.

More specifically, in a case where the user has set the style change in advance, the setting for the style change is reflected on the display element displayed on the user terminal 500.

In this case, at the start of the moving image, the display element of the state after the style change is displayed, on the user terminal 500 on which the moving image is displayed.

Thus, in the initial state of the moving image, for example, a display element after the transformation is performed and a display element after the transparency is changed is displayed, on the user terminal 500 on which the moving image is displayed.

Further, in the present exemplary embodiment, the above-described specific setting can be registered, and this specific setting can be applied to other input images. In other words, in the present exemplary embodiment, the setting for the style change can be registered, and the setting for the registered style change can be applied to other input images.

More specifically, in the present exemplary embodiment, the above-described specific setting can be registered in the information storage device 102 (see FIG. 2), and this specific setting can be read from the information storage device 102 and can be applied to other input images.

Thus, in the present exemplary embodiment, the display state of the display elements included in the other input image different from the input image on the user terminal 500 can be set to a state different from the display state in the other input image.

In other words, the state of the display elements in the initial state of the moving image can be set to a state different from the state of the display elements in the other input image. In other words, also in the other input image, the state of the display elements in the initial state of the moving image can be set to the state in which the above-described specific setting is reflected.

Further, in the present exemplary embodiment, a plurality of specific settings of different types can be registered in the information storage device 102, and the user can select one specific setting from the plurality of specific settings.

In other words, in the present exemplary embodiment, a plurality of settings for changing the style can be registered in the information storage device 102, and the user can select one setting from the plurality of settings.

In this case, the state of the display elements in the initial state of the moving image can be set to the state in which the specific setting selected by the user is reflected. Further, in this case, the state of the display elements in the initial state of the moving image can be set to various states, without being limited to one state.

The editing work by the user will be further described. In the present exemplary embodiment, in a case where the user performs the editing work on the display element, the user selects the display element 91 to be edited, from the display elements 91 displayed on the moving image display portion 620 (see FIG. 4).

In other words, in the present exemplary embodiment, in a case where the user changes the style or animation of the display element 91, the user selects the display element 91 to be edited, from the display elements 91 displayed on the moving image display portion 620.

FIG. 4 illustrates a case where the display element 91 represented by a reference numeral 4E is selected.

In the present exemplary embodiment, for the display element 91 selected by the user, as indicated by a reference numeral 4F, a reception image 93 for receiving a change in the shape of the display element 91 from the user is further displayed.

In the present exemplary embodiment, the user can change the shape of the display element 91 by performing an operation on the reception image 93. Specifically, the user can change the position of the outline of the display element 91 by performing an operation on the reception image 93.

More specifically, in the present exemplary embodiment, it is possible to make a setting for the “node”, and in a case of a setting for the node, the user changes the position of the outline of the display element 91 by performing an operation on the reception image 93.

Further, in the present exemplary embodiment, in a case where the user selects the display element 91, the change information (initial change information and user change information) already associated with the display element 91 is displayed at the first area 611 and the second area 612.

Further, in the present exemplary embodiment, in a case where the user selects the display element 91, the change information associated with the display element 91 other than the selected display element 91 is hidden, and the change information associated with the selected display element 91 is displayed.

In the present exemplary embodiment, in a case where the user selects the display element 91 and the initial change information or the user change information is associated with the display element 91, information regarding the change specified by the initial change information or the user change information that is already associated with the display element 91 is displayed in the first area 611 and the second area 612.

Specifically, timing information and change content information are displayed in each of the first area 611 and the second area 612.

In a case where the user selects the display element 91, the information displayed on the user terminal 500 is not limited to the information regarding the change, but also other information associated with the display element 91 selected by the user may be displayed on the edit screen 600.

Specifically, for example, information regarding the name of the display element 91, associated with the display element 91, may be displayed on the edit screen 600.

In this state shown in FIG. 4, in a case where the user wants to further change the display element 91 represented by the reference numeral 4E, the user performs, for example, an operation of selecting a part of the first area 611 or the second area 612, by operating, for example, an information input device such as a mouse.

More specifically, the user performs, for example, an operation of selecting a part of the first area 611 or the second area 612, by using an information input device such as a mouse, and specifies the timing at which the user wants to change the display.

More specifically, the user performs an operation of selecting, for example, a part indicated by a reference numeral 4G or 4H in FIG. 4.

In other words, the user refers to a location corresponding to the timing at which the user wants to change the display, of the first area 611 or the second area 612, by using an information input device such as a mouse.

Further, in a case of changing the node, for the display element 91, the user performs an operation on the moving image display portion 620 to change the position of the outline of the display element 91.

In the present exemplary embodiment, in a case where the user wants to further change the display element 91, the user first inputs information regarding the outline of the changes to the display element 91.

Specifically, as described above, the user performs, for example, an operation of selecting a part of the first area 611 or the second area 612 to input information regarding the outline of the change of the display element 91.

Specifically, the user performs an operation of selecting a part of the first area 611 in a case where the user wants to change the style, and the user performs an operation of selecting a part of the second area 612 in a case where the user wants to change the animation, thereby inputting information regarding the outline of the changes the user wants to make.

In the present exemplary embodiment, in a case where the user selects a part of the first area 611 or the second area 612 and the reception display 640 is not displayed, the reception display 640 is displayed on the display unit 501 of the user terminal 500.

Specifically, the first reception screen 641 and the second reception screen 642 are displayed so as to be selectable by the user, on the display unit 501 of the user terminal 500.

More specifically, in a case where the user selects a part of the first area 611, the CPU 111 of the management server 300 causes the first reception screen 641 to be displayed on the display unit 501 of the user terminal 500, and the second reception screen 642 to be located behind the first reception screen 641.

Further, in a case where the user selects a part of the second area 612, the CPU 111 of the management server 300 causes the second reception screen 642 to be displayed on the display unit 501 of the user terminal 500 and the first reception screen 641 to be located behind the second reception screen 642.

In the present exemplary embodiment, in a case where the user selects a part of the first area 611, the user wants to change the style.

In this case, the CPU 111 of the management server 300 causes the first reception screen 641 for receiving the style change to be displayed in the area on the left side of the edit screen 600, and the second reception screen 642 to be located behind the first reception screen 641.

Further, in a case where the user selects a part of the second area 612, the user wants to change the animation.

In this case, the CPU 111 of the management server 300 causes the second reception screen 642 for receiving the animation change to be displayed in the area on the left side of the edit screen 600, and the first reception screen 641 to be located behind the second reception screen 642.

Further, in the present exemplary embodiment, it is also assumed a case where the reception display 640 is displayed but the content of this selection and the display content of the reception display 640 do not match in a case where the user selects a part of the first area 611 or the second area 612.

In this way, in a case where the content of the selection and the display content of the reception display 640 do not match, in the present exemplary embodiment, the reception display 640 is changed such that the content of the selection and the display content of the reception display 640 match each other.

Specifically, in a case where the user selects a part of the first area 611 and the second reception screen 642 is displayed, the CPU 111 of the management server 300 causes a first reception screen 641 to be displayed.

Further, in a case where the user selects a part of the second area 612 and the first reception screen 641 is displayed, the CPU 111 of the management server 300 causes a second reception screen 642 to be displayed.

Further, in the present exemplary embodiment, in a case where the user selects a part of the first area 611 or the second area 612, and the content of this selection and the display content of the reception display 640 match each other, the display of the reception display 640 is maintained.

Specifically, in a case where the user selects a part of the first area 611 and the first reception screen 641 is displayed, the CPU 111 of the management server 300 maintains the display of the first reception screen 641.

Further, in a case where the user selects a part of the second area 612 and the second reception screen 642 is displayed, the CPU 111 of the management server 300 maintains the display of the second reception screen 642.

Further, in the present exemplary embodiment, in a case where the user selects a part of the first area 611 or the second area 612, the CPU 111 of the management server 300 receives the part selected by the user, as a start point of change (hereinafter referred to as “change start point”).

A first reception screen 641 for receiving a style change will be described with reference to FIG. 6 (a diagram for explaining the reception display 640).

In the present exemplary embodiment, the selection items “transformation” and “transparency” are displayed on the first reception screen 641, and the user makes a setting for “transformation” and “transparency” as style changes.

In a case where the user makes a setting for transformation, the screen shown in FIG. 6 is displayed.

In the present exemplary embodiment, an information input field 911 for anchor point (reference position), an information input field 912 for transformation mode, and an information input field 913 for transformation start time are displayed on the first reception screen 641.

In the present exemplary embodiment, as described in the information input field 912 for transformation mode, the movement, scaling, and rotation of the display element 91 can be performed, as transformation. Here, in the present exemplary embodiment, as described as “scaling”, the display element 91 can be reduced as well as enlarged.

The user inputs a specific numerical value indicating how much movement, scaling, and rotation are performed, to the information input field 912 for transformation mode

Further, the user inputs a specific numerical value for the transformation start time, to the information input field 913 for transformation start time.

In the present exemplary embodiment, as described above, in a case where the user selects a part of the first area 611, the time corresponding to the part selected by the user is automatically input to the information input field 913 for transformation start time.

In the present exemplary embodiment, in a case where the user performs an operation on the first reception screen 641 and makes a setting for the change, timing information indicating when the change is made is displayed in the location indicated by the reference numeral 4G in FIG. 4 (the above change start point designated by the user in the first area 611).

Here, the case where only the timing information is displayed is described as an example, but without being limited to this, as described above, the change content information, which is the information indicating the content of the change may be displayed at the change start point designated by the user in the first area 611.

In other words, in addition to the timing information indicating when the transformation is performed, the change content information, which is the information indicating the content of the change, may be further displayed at the location corresponding to the change start point.

Examples of the change content information include text information “transformation”. Further, the change content information is not limited to the text information, and may be displayed in another display form such as a figure or an illustration.

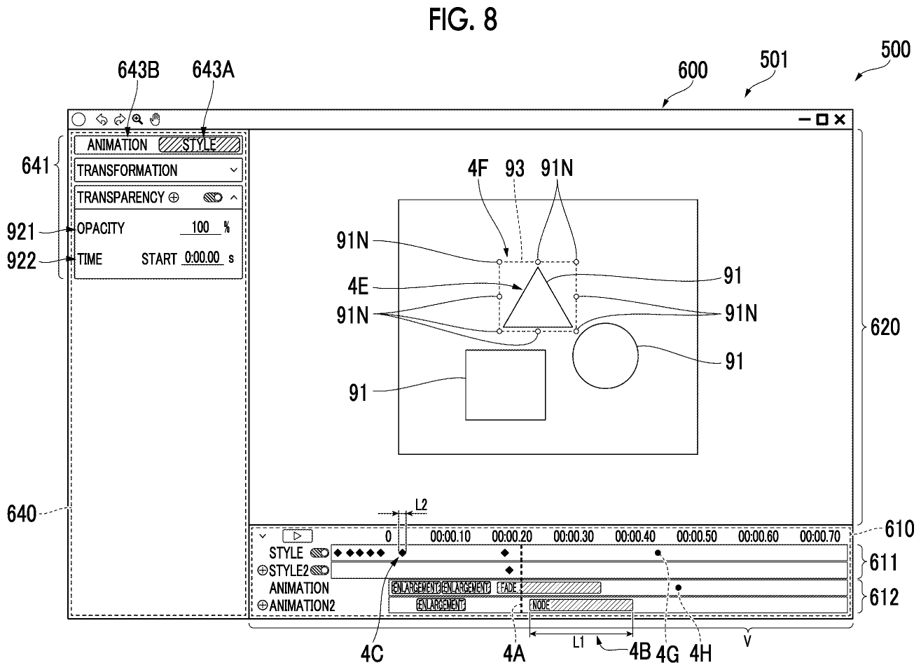

Next, the setting for “transparency” will be described. In a case where the user makes a setting for “transparency”, the user selects a location indicated by a reference numeral 6K in FIG. 6. Thus, the display is switched, and the reception display 640 is in the state shown in FIG. 8 (a diagram for explaining the reception display 640).

In the setting for “transparency”, as shown in FIG. 8, an information input field 921 for opacity and an information input field 922 for start time are displayed.

Here, the opacity is an index indicating the transparency of the display element 91. The user inputs a specific numerical value for the opacity in the information input field 921 for opacity. In other words, the user inputs a specific number that indicates the opacity.

Further, the user inputs a specific time indicating the timing for changing the opacity of the display element 91 in the information input field 922 for start time.

In the present exemplary embodiment, as described above, in a case where the user has already selected a part of the first area 611, the time corresponding to the part selected by the user is automatically input to the information input field 922 for transformation start time.

In the present exemplary embodiment, in a case where the user makes the setting for the transparency, timing information, which is information indicating when this transparency change is made, is displayed, at the change start point designated by the user in the first area 611, as in the above.

As in the above, in addition to this timing information, the change content information such as the text information “transparent” may be further displayed.

In the present exemplary embodiment, the configuration example in which the transparency of the display element 91 is changed has been described as an example, but without being limited to this, the color of the display element 91 may be changed.

FIG. 7 is a diagram for explaining a second reception screen 642 for receiving the animation change.

In the present exemplary embodiment, the selection items “fade”, “enlargement”, and “node” are displayed on the second reception screen 642, and the user makes a setting for “fade”, “enlargement”, and “node”, as the setting for the animation change.

Here, the “fade” refers to a setting to gradually increase or decrease the brightness of the display element 91.

In the setting for the fade, as shown in FIG. 7, an information input field 931 for fade type, an information input field 932 for fade opacity, an information input field 933 for fade mode, and an information input field 934 for required time required for fade are displayed.

In the present exemplary embodiment, information for required time required for fade is input by inputting a time to start the fade and a time to end the fade, to the information input field 934 for required time required for fade.

In the present exemplary embodiment, as described above, in a case where the user has already selected a part of the second area 612, the time corresponding to the part selected by the user is automatically input to the input field for a time to start fading.

Further, in the present exemplary embodiment, in a case where the user selects a part of the second area 612 or the user makes this selection in a form having a time width, the time corresponding to the part the user selects is also automatically input to input field for the time to end the fade.

In the present exemplary embodiment, either fade-in or fade-out can be performed as the fade type, and the user operates the information input field 931 for fade type to select the fade type wanted by the user.

Further, in the present exemplary embodiment, the opacity of the display element 91 can be set, and the user inputs a specific numerical value for the opacity to the information input field 932 for fade opacity.

Further, in the present exemplary embodiment, it is possible to receive the setting for the round trip of the animation from the user, in the information input field 933 for fade mode.

Here, “round trip” means that one process is performed, and after this one process, the process opposite to this one process is performed.

In the present exemplary embodiment, as the process for round trip, a process of performing a fade-out after the fade-in and a process of performing a fade-in after the fade-out are performed.

In the present exemplary embodiment, the user operates the information input field 933 fade mode to set the round trip of the animation.

Further, in the present exemplary embodiment, the user inputs a specific numerical value of the required time for the fade, to the information input field 934 for required time.

In the present exemplary embodiment, the user inputs information regarding “fade”, by performing an operation on the second reception screen 642 shown in FIG. 7. Thus, the user can make a setting for “fade”, for the display element 91 selected by the user.

In the present exemplary embodiment, in a case where the user makes a setting for the fade, timing information, which is information indicating when the change for the fade is made, is displayed in the second area 612.

Specifically, the timing information is displayed in a form extending to the right from the change start point, with the above change start point as a reference. Further, at the display location of the timing information, the text information “fade” is displayed as the change content information which is the information indicating the content of the change.

Here, the display length of the timing information regarding the fade increases or decreases according to the set required time of the fade, and the longer the required time of the fade, the larger the display length.

Next, “enlargement” will be described.

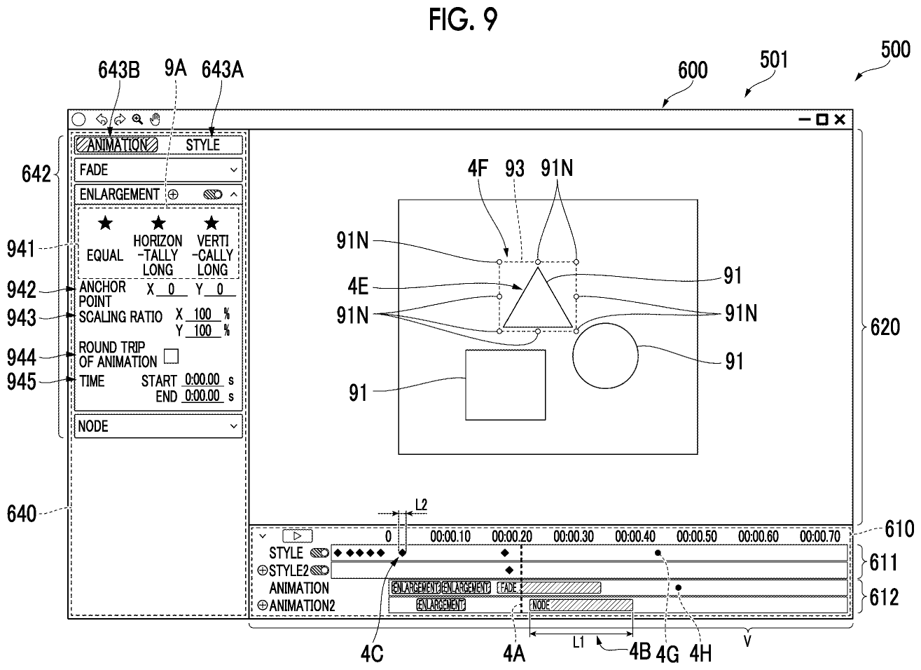

In the setting for “enlargement”, as shown in FIG. 9 (a diagram for explaining the reception display 640), an information input field 941 for enlargement type, an information input field 942 for anchor point (reference position), an information input field 943 for scaling ratio, an information input field 944 for enlargement mode, and an information input field 945 for time required for enlargement are displayed.

As in the above, also here, as described as “scaling”, the display element 91 can be reduced as well as enlarged.

Further, as in the above, also here, in the setting of the required time required for enlargement, the setting for the time required for enlargement is made by inputting the time to start the enlargement and the time to end the enlargement.

Further, as in the above, in a case where the user has already selected a part of the second area 612, the time corresponding to the part selected by the user is automatically input to the input field for a time to start fading.

Further, in a case where the user selects a part of the second area 612 or the user makes this selection in a form having a time width, the time corresponding to the part the user selects is also automatically input to the input field for a time to end enlargement.

In the present exemplary embodiment, as indicated by a reference numeral 9A, three types of enlargement, equal, horizontally long, and vertically long, are prepared in advance.

The user selects the type of enlargement that the user wants, from these three types. More specifically, the user operates an information input field 941 for enlargement type, and selects the type of enlargement wanted by the user.

Here, the term “equal” means that scaling is performed such that the scaling ratio in the horizontal direction and the scaling ratio in the vertical direction are equal to each other.

Further, the term “horizontally long” means that scaling is performed such that the scaling ratio in the horizontal direction is larger than the scaling ratio in the vertical direction.

Further, the term “vertically long” means that scaling is performed such that the scaling ratio in the vertical direction is larger than the scaling ratio in the horizontal direction.

Further, in the present exemplary embodiment, in the setting for the enlargement, the user inputs a specific numerical value for the anchor point (reference position) to the information input field 942 for anchor point (reference position).

Further, the user inputs a specific numerical value for the scaling ratio, to the information input field 943 for scaling ratio.

Further, in the present exemplary embodiment, the user also makes a setting for the round trip of the animation for “enlargement”, and the user operates the information input field 944 for the enlargement mode to make a setting for a round trip.

Further, as described above, the user inputs a specific numerical value for the time required for “enlargement” in the information input field 945 for required time.

In the present exemplary embodiment, the user inputs information regarding “enlargement”, by performing an operation on the second reception screen 642 shown in FIG. 9. Thus, the user can make a setting for “enlargement”, for the display element 91 selected by the user.

In the present exemplary embodiment, in a case where the user makes a setting for “enlargement”, the timing information corresponding to this “enlargement” is displayed in the second area 612. More specifically, for example, the timing information is displayed in a form extending to the right from the change start point, with the above change start point as a reference.

Further, at the display location of the timing information, the text information “enlargement” is displayed as the change content information which is the information indicating the content of the change.

Here, as described above, the display length of the displayed timing information regarding the enlargement increases or decreases according to the required time for the enlargement, and the longer the required time, the larger the display length.

Next, the setting for “node” will be described. In the setting for “node”, the user makes a setting for the position of each node. In other words, in the setting of node, the user makes a setting for the position of the outline of the display element 91.

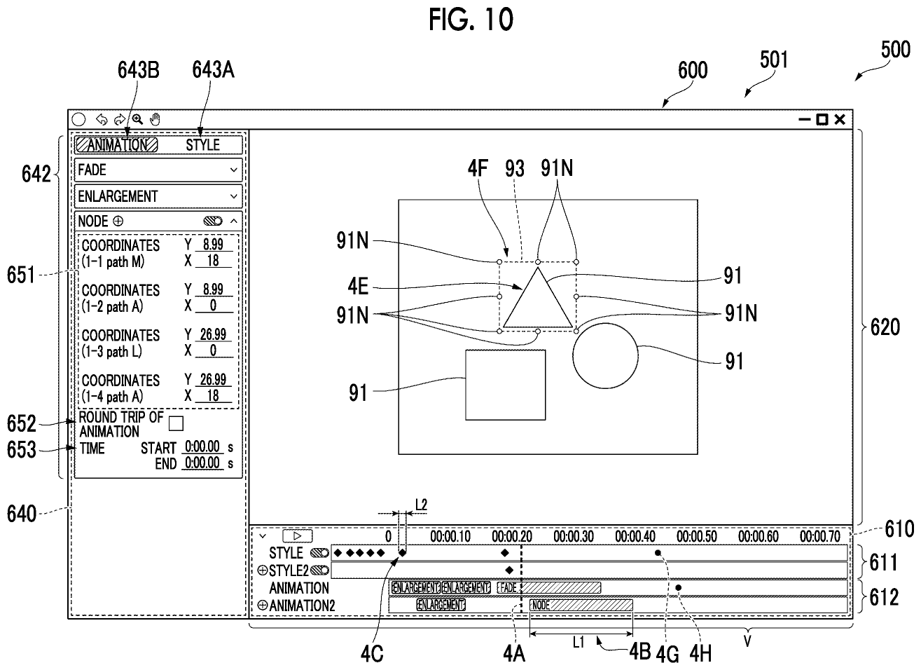

More specifically, in the present exemplary embodiment, in the setting for the “node”, as shown in FIG. 10 (a diagram for explaining the reception display 640), the coordinate input field 651 for inputting the position coordinates of each of the plurality of nodes 91N constituting the outline of the display element 91 is displayed.

With respect to each of the nodes 91N, the user sets the position of the node 91N by inputting the position coordinates to the coordinate input field 651.

Further, in the setting for the node 91N, as in the above, an information input field 652 for change mode and an information input field 653 for required time, which is a time required for changing the node 91N, are displayed.

as in the above, also here, in the setting for the required time required to change the node 91N, the setting for the required time required to change the node 91N is made by inputting the time to start the change and the time to end the change.

Further, as in the above, in a case where the user has already selected a part of the second area 612, the time corresponding to the part selected by the user is automatically input to the input field for start time.

Further, in a case where the user selects a part of the second area 612 or the user makes this selection in a form having a time width, the time corresponding to the part the user selects is also automatically input to the input field for a time to end.

In the information input field 652 for change mode, the setting for the round trip of the animation is received from the user, as described above. In the change of the node 91N, the round trip means to perform the process of changing the position of the contour of the display element 91 and then the process of returning the contour to the original position.

Further, in the present exemplary embodiment, as described above, the user inputs a specific numerical value as the required time for the node 91N, to the information input field 653 for required time.

In the present exemplary embodiment, in a case where the user makes a setting for the node 91N, the timing information corresponding to this node 91N is displayed in the second area 612.

Specifically, as in the above, the timing information is displayed in a form extending to the right in FIG. 9 from the change start point, with the above change start point as a reference.

Further, at the display location of the timing information, for example, the text information “node” is displayed as the change content information which is the information indicating the content of the change, as described above.

Here, as described above, the display length of the displayed timing information regarding this “node” increases or decreases according to the required time for the “node”, and the longer the required time, the larger the display length.

On the second reception screen 642 shown in FIG. 10, the user inputs a specific numerical value to set the movement amount of each node 91N.

In the present exemplary embodiment, in addition to this, as shown in FIG. 10, each of the nodes 91N is displayed on the moving image display portion 620, and the user can also set the movement amount of each node 91N by directly performing an operation on the node 91N.

In other words, in the present exemplary embodiment, the user directly changes the position of the outline of the display element 91, by operating an information input device such as a mouse to move each of the displayed nodes 91N on the moving image display portion 620.

In the present exemplary embodiment, as described above, in a case where the user selects the display element 91, the reception image 93 for receiving the user's direct operation on the outline of the display element 91 from this user is displayed on the moving image display portion 620.

In other words, in the present exemplary embodiment, in a case where the user selects the display element 91, the node 91N is displayed on the outline of the display element 91, and the user changes the position of the outline of the display element 91, by moving the node 91N.

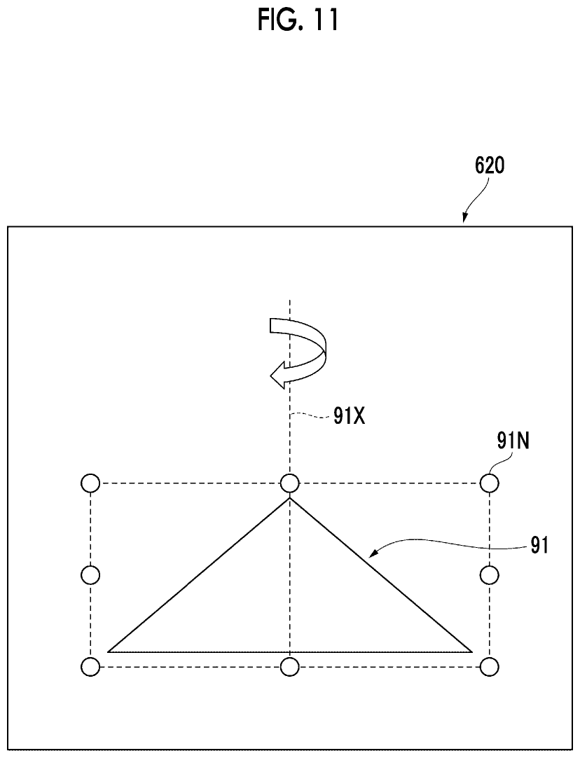

In addition to that, in a case where the display element 91 on the moving image display portion 620 is selected by the user, the display shown in FIG. 11 (a diagram showing a display example in the moving image display portion 620) may be performed on the moving image display portion 620.

In this display example shown in FIG. 11, a plurality of nodes 91N are displayed corresponding to the display element 91, as in the above. Further, in this display example, the rotation axis 91X is displayed on the moving image display portion 620 by the user performing a predetermined operation, and in the display example shown in FIG. 11, the rotation axis 91X is displayed.

In this display example shown in FIG. 11, the user can set the rotation of the display element 91 around the rotation axis 91X, by performing an operation on the moving image display portion 620.

Here, a case where the user sets the rotation of the display element 91 around the rotation axis 91X will be described, but without being limited to the rotation, a setting for the movement of the display element 91 may be made, by direct operation on the moving image display portion 620.

Specifically, in a case where the user selects the display element 91 on the moving image display portion 620 and then moves the display element 91, the user may receive that the movement has been set.

The display shown in FIG. 11 is performed based on an instruction from the CPU 111 of the management server 300.

That is, in the present exemplary embodiment, the CPU 111 of the management server 300 outputs an instruction such that a display for receiving the mode of movement of the display element 91 displayed on the moving image display portion 620 from the user and a display for receiving the mode of rotation of the display element 91 displayed on the moving image display portion 620 from the user are performed on the moving image display portion 620.

In response to this, in the present exemplary embodiment, the display shown in FIG. 11 is performed on the moving image display portion 620.

In the state shown in FIG. 11, in a case where the user performs an operation on the moving image display portion 620, the CPU 111 of the management server 300 receives the content of this operation, and acquires information regarding the setting made by the user, based on the content of this operation.

Specifically, the CPU 111 of the management server 300 acquires the setting information regarding the movement of the display element 91 and the setting information regarding the rotation of the display element 91.

Then, the CPU 111 of the management server 300 reflects the acquired information regarding this setting in the above vector data.

In addition, in the display example shown in FIG. 11, the case has been described where two displays, that is, a display for receiving the mode of movement of the display element 91 from the user and a display for receiving the mode of rotation of the display element 91 from the user are displayed on one moving image display portion 620.

However, without being limited to this, these two displays may be respectively displayed on separate edit screens 600, and by switching between the edit screens 600, each of these two displays may be displayed.

In the above, a case has been described as an example where in editing of the display element 91 by the user, a part of the first area 611 and the second area 612 is selected first by the user, and then the user performs an operation on the first reception screen 641 and the second reception screen 642.

In the present exemplary embodiment, without being limited to this, an aspect is assumed in which the user first performs an operation on the first reception screen 641 and the second reception screen 642, without selecting a part of the first area 611 and the second area 612.

In this case, the user first performs an operation on the first reception screen 641 and the second reception screen 642, and inputs various types of information regarding the change.

After that, in this case, the CPU 111 of the management server 300 causes the timing information and the change content information to be displayed in the first area 611 and the second area 612, based on the information input by the user.

Further, although the description is omitted above, in the present exemplary embodiment, as shown in FIG. 5, a pre-start display area 619 is present on the left side of FIG. 5 from the first area 611 and the second area 612.

In the present exemplary embodiment, as described above, the user may make a specific setting in advance regarding the style change. In this case, in the present exemplary embodiment, as described above, before the start of playback of the moving image, the display element 91 is changed according to the specific setting.

In the present exemplary embodiment, information regarding the change of the display element 91, which is performed before the start of the playback of the moving image, is displayed in the pre-start display area 619.

In the present exemplary embodiment, as described above, the user can set the style change as the above-described specific setting. Specifically, the user can set one or both of “transformation” and “transparency” in the above-described specific setting to be performed in advance.

In the present exemplary embodiment, in a case where the user has set the “transformation” and “transparency” as the above-described specific setting, timing information indicating when “transformation” and “transparency” are performed is displayed in the pre-start display area 619.

Thus, the user can grasp that the specific setting has already been made, by referring to the pre-start display area 619. Further, in this case, the user can grasp that the initial state of the moving image is different from the initial state of the input image.

Further, in the present exemplary embodiment, the user performs an operation on the pre-start display area 619, and similarly to the above, the user can set the style change performed before the start of playback of the moving image, by performing an operation on the pre-start display area 619.

In a case where the user performs an operation on the pre-start display area 619, the user designates a part of the pre-start display area 619.

Next, the user sets the style change before the start of playback of the moving image, performing an operation on the first reception screen 641 (see FIG. 6).

In a case where the setting for this style change is completed by the user, as described above, the timing information indicating when this style change is performed is displayed in the pre-start display area 619.

In the present exemplary embodiment, as described above, the user sets the outline of the content of the change, by selecting, for example, a part of the first area 611 and the second area 612 that have a role as a timeline.

Next, the user makes a detailed setting for the change via the first reception screen 641 and the second reception screen 642 displayed in conjunction with the partial selection.

Further, in the present exemplary embodiment, the pre-start display area 619 is displayed, and the user can obtain information regarding the style change performed before the start of the playback of the moving image.

Further, the user can set the style change performed before the start of the playback of the moving image, by performing the operation on the pre-start display area 619.

Further, in the present exemplary embodiment, the user directly operates the display element 91 selected by the user. More specifically, the user directly operates the selected display element 91, by selecting the node 91N or selecting the display element 91 itself.

In the case of the configuration in which the node 91N can be selected, as in the present exemplary embodiment, the user sets the movement of a part of the display element 91 selected by the user.

In the above, the case where the required time cannot be set for “transformation” and “transparency”, which are examples of style changes, has been described as an example, but for these “transformation” and “transparency”, the required time may be set.

In a case where the required time can be set for the style change, for example, it is preferable to increase or decrease the display length of the timing information, according to the required time, as described above.

Further, in the above, the case is explained in which only the timing information is displayed and the content change information is not displayed for “transformation” and “transparency” which are examples of style change.

However, without being limited to this, the content change information may be displayed for “transformation” and “transparency” which are examples of style changes. Specifically, for example, text information of “transformation” and “transparency”, and an image, an illustration and the like representing “transformation” and “transparency” may be displayed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system that processes a display element displayed on a display unit, comprising:
a processor configured to:
acquire change information including a change content of display according to a time series performed on the display element; and
determine a display content of an edit screen for providing an instruction to change the display of the display element according to the time series, based on the acquired change information.

2. The information processing system according to claim 1, wherein the processor is configured to:
display information regarding a name of the display element, associated with the display element, on the edit screen.

3. The information processing system according to claim 1,
wherein the edit screen is provided with a display area corresponding to the time series, and
the processor is configured to:
determine a display content in the display area of the edit screen, based on the acquired change information.

4. The information processing system according to claim 3, wherein the processor is configured to:
display timing information, which is information indicating when the display element is changed, in the display area of the edit screen.

5. The information processing system according to claim 1, wherein the processor is configured to:
determine a display position of timing information, which is information indicating when the display element is changed, based on the acquired change information, and
vary the display position of the timing information, depending on whether a change specified by the acquired change information is a first change or a second change different from the first change.

6. The information processing system according to claim 5,
wherein the edit screen is provided with a plurality of display areas corresponding to the time series, and
the processor is configured to:
display the timing information in a first area, in a case where the change specified by the acquired change information is the first change, and
display the timing information in a second area different from the first area, in a case where the change specified by the acquired change information is the second change different from the first change.

7. The information processing system according to claim 6,
wherein the first area and the second area are areas extending along one direction.

8. The information processing system according to claim 7, wherein the processor is configured to:
display the timing information in the first area and display the timing information in the second area such that a display standard in the one direction in a case where the timing information is displayed in the first area matches a display standard in the one direction in a case where the timing information is displayed in the second area.

9. The information processing system according to claim 5, wherein the processor is configured to:
vary the display position of the timing information, depending on whether the change specified by the acquired change information is a time-requiring change that is a change requiring time to change the display, or a short-time change that is a change requiring shorter time for changing than the time-requiring change.

10. The information processing system according to claim 9, wherein the processor is configured to:
increase an area in which the timing information is displayed, in a case where the change specified by the acquired change information is the time-requiring change, as compared with a case of the short-time change.

11. The information processing system according to claim 1, wherein the processor is configured to:
display timing information, which is information indicating when the display element is changed, on the display unit,
display the timing information in a first area, in a case where a change specified by the acquired change information is one type of change,
display the timing information in a second area, in a case where the change specified by the acquired change information is another type of change,
further perform a reception display, which is a display for receiving further changes in the display element from a user, and
display, as the reception display, a first reception screen for the user to receive a content of the one type of change and a second reception screen for the user to receive a content of the other type of change.

12. The information processing system according to claim 11, wherein the processor is configured to:
when one of the first reception screen and the second reception screen is displayed, prohibit the other from being displayed.

13. The information processing system according to claim 1, wherein the processor is configured to:
acquire the display element displayed on the display unit, from an input image that is an image input, and
perform a process of receiving a display setting for a background image included in the input image on the display unit, from a user.

14. The information processing system according to claim 1, wherein the processor is configured to:
acquire the display element displayed on the display unit, from an input image that is an image input, and
in a case where a specific setting is made in advance by a user, set a state of the display element displayed on the display unit to a state different from a state of the display element in the input image, based on the specific setting.

15. The information processing system according to claim 14,
wherein the specific setting is capable of being registered, and
a display state of a display element included in another input image different from the input image on the display unit is capable of being set to a state different from the display state in the other input image, by using the registered specific setting.

16. The information processing system according to claim 1, wherein the processor is configured to:
perform a display for receiving a user's operation on an outline of the display element displayed on the display unit from a user, on the display unit.

17. The information processing system according to claim 1, wherein the processor is configured to:
perform a display for receiving a mode of movement of the display element displayed on the display unit from a user and/or a display for receiving a mode of rotation of the display element from the user.

18. An information processing system that processes a display element displayed on a display unit, comprising:
means for acquiring change information including a change content of display according to a time series performed on the display element; and
means for determining a display content of an edit screen for providing an instruction to change the display of the display element according to the time series, based on the acquired change information.
